(19) United States
(12) Patent Application Publication
(10) Pub. No.: US 2019/0143174 A1
(43) Pub. Date: May 16, 2019

(54) MOTION TRAINING GUIDE SYSTEM BASED ON WEARABLE SENSOR AND METHOD THEREOF

(71) Applicant: CULTURIT Co., Ltd., Seoul (KR)

(72) Inventor: Sung Hyun PARK, Bucheon-si (KR)

(73) Assignee: CULTURIT Co., Ltd., Seoul (KR)

(21) Appl. No.: 15/821,851

(22) Filed: Nov. 24, 2017

(30) Foreign Application Priority Data
Nov. 15, 2017 (KR) 10-2017-0152236

(51) Int. Cl. A63B 24/00; G09B 5/02; G09B 5/04

(52) U.S. Cl. CPC A63B 24/0006; A63B 2225/50; G09B 5/04; A63B 24/0062; A63B 2220/836; A63B 2024/0012; A63B 2230/705; A63B 2230/755; A63B 2230/015; A63B 2230/00; A63B 2220/20; A63B 2220/30; A63B 2220/62; A63B 2220/40; A63B 2220/803; G09B 5/02

(57) ABSTRACT

The present disclosure includes collecting motion data that is obtained at the time of a setting motion of a user using N sensors which are individually attached to N regions, for a plurality of users; doing deep learning of the motion data, and acquiring reference motion ranges of each region; acquiring the motion data using M sensors that are attached to M regions of the learner during the setting motion of the learner, comparing with the reference motion ranges, and guiding a motion of the learner by providing comparison results; comparing the amount of exercise of the learner with a reference amount of exercise, if the motion data of each of the M regions satisfies all corresponding reference motion ranges; and providing a notification message which induces attachment of an additional sensor, if the amount of exercise of the learner does not satisfy the reference amount of exercise.

### RELATED APPLICATIONS

This application claims priority and the benefit of Korean Patent Application No. 10-2017-0152236, filed on Nov. 15, 2017, in the Korean Intellectual Property Office, the entire contents of which are incorporated herein by reference in their entirety.

### BACKGROUND

### 1. Field

Exemplary embodiments of the present disclosure relate to a motion training guide system based on a wearable sensor and a method thereof, and in more detail, to a motion training guide system based on a wearable sensor that can induce correction of a posture by guiding a motion of a learner, based on motion data of a wearable sensor attached to each region of a body and a method thereof.

### 2. Description of the Related Art

In order to obtain accuracy and repeatability of exercise for the purpose of body management, health care, and the like, a home training user needs direct exercise equipment and contents.

A solution based on a motion camera lacks precision of joint angle measurement and cannot interact with a customer, thereby, limiting motivation of a user. In addition, a solution based on a mobile video (yoga, health, diet, and the like) does only one-dimensional learning and can cause boredom and disinterest in exercise due to unsteady gaze treatment of a user and repetition of an incorrect motion.

A trainer studies a new exercise method with various exercise equipment to steadily update related videos, but it is difficult to continuously manage membership only by uploading lecture videos.

In addition, among the users who correct the posture through a regular personal training (PT) once a week, some people exercise in an incorrect position according to their own habits after a certain period of time, thereby, not being satisfied with their exercise results.

In addition, a body composition analyzing apparatus such as the Inbody is a device that provides data on actual exercise results, but since most users often exercise in a personal space that is difficult to access the apparatus, there is a problem that is not easy to confirm the exercise results.

A technology that provides a background of the present disclosure is disclosed in Korea Patent No. 10-1582347 (published on Jan. 1, 2014).

### SUMMARY OF THE DISCLOSURE

Exemplary embodiments of the present disclosure are to provide a motion training guide system based on a wearable sensor that can induce correction of a posture by guiding a motion of a learner, based on motion data of the wearable sensor attached to each region of the body and a method thereof.

According to one embodiment of the present disclosure, there is provided a motion training guide method based on a wearable sensor including collecting motion data that is obtained at the time of a setting motion of a user using N sensors which are individually attached to N regions of the user, for a plurality of users; doing deep learning of the motion data that is collected, and acquiring and storing reference motion ranges of each region corresponding to the setting motion; acquiring the motion data using M sensors that are attached to M regions (a part of the N regions) of the learner during the setting motion of the learner, comparing the motion data which is obtained with the reference motion ranges, and guiding a motion of the learner by providing comparison results; comparing the amount of exercise of the learner that is calculated based on the motion data with a reference amount of exercise on the setting motion, if the motion data of each of the M regions satisfies all corresponding reference motion ranges; and providing a notification message which induces attachment of an additional sensor to a region other than the M regions to remeasure a motion, if the amount of exercise of the learner does not satisfy the reference amount of exercise.

Here, the amount of exercise may include the amount of consumption or the amount of increase of at least one of body fat, calories, a weight, and muscle mass.

In addition, the deep learning may include doing deep learning of the motion data on each of a plurality of types of body conditions that are classified from a plurality of users, and acquiring, classifying, and storing the reference motion ranges of each of the regions for each of the body conditions, and the providing of the comparison results may include extracting the reference motion ranges corresponding to the body conditions of the learner and comparing the motion data that is acquired at the time of the setting motion of the learner with the reference motion range that is extracted.

In addition, the body conditions may include at least one of sex, an age, a weight, and a height.

In addition, the providing of the notification message includes selecting at least one region to which additional sensor is attached based on the setting motion and positions of the M regions of the body, and recommending and providing the selected region to the learner.

In addition, the providing of the notification message may include preferentially selecting, recommending, and providing predetermined regions corresponding to positions which are vertically or horizontally symmetrical with at least one of the M regions so as to induce vertically or horizontally balanced attachment of the sensors to the body.

In addition, M may be initially selected in a range of 4≤M≤6, and the motion data may be processed from a sensing value of the sensor and may include at least one of a movement angle, a moving distance, a moving speed, a posture holding time, and a motion repetition period, on the region.

According to another embodiment of the present disclosure, there is provided a motion training guide system based on a wearable sensor including a data collection unit configured to collect motion data that is obtained at the time of a setting motion of a user using N sensors which are individually attached to N regions of the user, for a plurality of users; a storage unit configured to do deep learning of the motion data that is collected and configured to acquire and store reference motion ranges of each region corresponding to the setting motion; a provision unit configured to acquire the motion data using M sensors that are attached to M regions (a part of the N regions) of the learner during the setting motion of the learner, configured to compare the motion data which is obtained with the reference motion ranges, and configured to guide a motion of the learner by providing comparison results; a determination unit configured to compare the amount of exercise of the learner that is calculated based on the motion data with a reference amount of exercise on the setting motion, if the motion data of each of the M regions satisfies all corresponding reference motion ranges; and a notification unit configured to provide a notification message which induces attachment of an additional sensor to a region other than the M regions to remeasure a motion, if the amount of exercise of the learner does not satisfy the reference amount of exercise.

In addition, the storage unit may do deep learning of the body conditions collected for the users and the motion data, and may acquire, classify, and store reference motion ranges of each region corresponding to the setting motion for each of a plurality of types of body conditions, and the provision unit may extract the reference motion ranges corresponding to the body conditions of the learner and may compare the motion data that is acquired at the time of the setting motion of the learner with the reference motion range that is extracted.

In addition, the notification unit may select at least one region to which additional sensor is attached based on the setting motion and positions of the M regions of the body, and may recommend and provide the selected region to the learner.

In addition, the notification unit may preferentially select, recommend, and provide predetermined regions corresponding to positions which are vertically or horizontally symmetrical with at least one of the M regions so as to induce vertically or horizontally balanced attachment of the sensors to the body.

According to the present disclosure described above, there are effects that motion data obtained through sensors attached to each region of a body of a learner when the learner performs a setting motion is compared with a reference motion range previously stored, and thereby, not only correction of postures is induced since the postures for each region corresponding to the setting motion are guided, but also exercise, training, and rehabilitation can be made by attaching only the minimum number of sensors.

In addition, even if the motion data on each region satisfies all the reference motion ranges, if the amount of exercise of the learner is less than the reference amount of exercise, a region to which an additional sensor is attached is recommended and re-measurement for the additional attachment of the sensor is induced, and thereby, accuracy of a posture of the learner for a setting motion can be further increased and the reference amount of exercise can be satisfied.

Furthermore, the present disclosure differently applies reference motion ranges depending on body conditions of a learner so as to support a safe exercise corresponding to the body conditions of the learner, and thereby, injury can be prevented during exercise by preventing a posture from being formed in an excessive size or angle above the body conditions of the learner.

### BRIEF DESCRIPTION OF THE DRAWINGS

FIG. 1 is a diagram illustrating a configuration of a motion training guide system according to an embodiment of the present disclosure.

FIG. 2 is a view illustrating a sensor attachment position for data learning in the embodiment of the present disclosure.

FIG. 3. shows (a) and (b) which are views illustrating a state where sensors are attached to regions of the body of a learner in the embodiment of the present disclosure.

FIG. 4 is a flowchart illustrating a motion training guide method which uses the system of FIG. 1.

### DETAILED DESCRIPTION OF THE EMBODIMENT

Exemplary embodiments of the present disclosure will be described in detail with reference to the accompanying drawings so as to be readily implemented by the skilled in the technical field of the present disclosure.

The present disclosure relates to a motion training guide system based on a wearable sensor and proposes a system which can guide a correct posture of a user with respect to a setting motion by using a plurality of wearable sensors (hereinafter, referred to as sensors) attached to each region of the body and enables exercise, rehabilitation, and the like only by installing the minimum number of sensors.

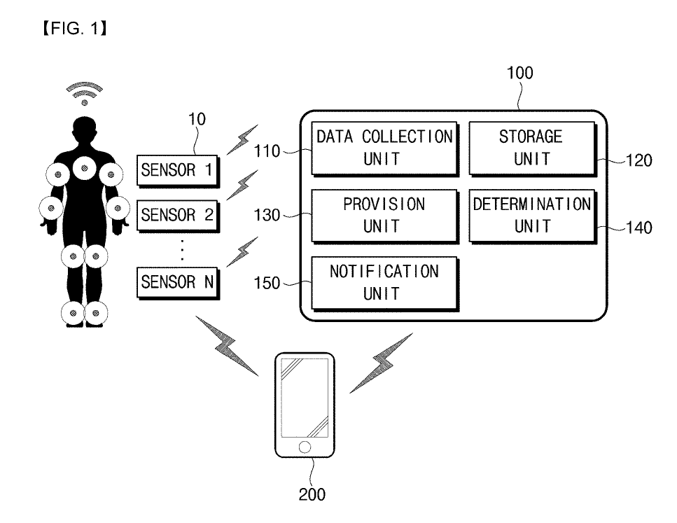

FIG. 1 is a diagram illustrating a configuration of a motion training guide system according to an embodiment of the present disclosure.

As illustrated in FIG. 1, the motion training guide system 100 according to the embodiment of the present disclosure includes a data collection unit 110, a storage unit 120, a provision unit 130, a determination unit 140, and a notification unit 150.

The motion training guide system 100 according to the embodiment of the present disclosure may be connected to a plurality of sensors 10 and a user terminal 200 through a wired/wireless network to transmit and receive information. Hereinafter, a wireless network is mainly exemplified, but a wireless network, a wired network, or a wired/wireless combined network may be used.

In FIG. 1, the plurality of sensors 10 are wearable devices, each of which can be attached to a region of the body of a user to sense movement of the corresponding region. The sensor 10 may have sensing functions of an acceleration sensor, a gyro sensor, a geomagnetic sensor, and the like, and may be realized by an ordinary inertial measurement unit (IMU) sensor.

Each of the sensors 10 can transmit and receive data through a wireless communication (for example, Bluetooth communication, RF communication, Wi-Fi communication) method, and may be worn on a region of the body to receive motion data.

The sensors 10 may be wirelessly connected to the motion training guide system 100 to wirelessly transmit and receive data. Of course, the sensors 10 may be wirelessly connected to the user terminal 200. In a case of FIG. 1, the system 100 and the user terminal 200 are classified as separate devices, but the present disclosure is not limited to this. For example, if the system 100 includes a user interface, a configuration of the user terminal 200 may be omitted.

The motion training guide system 100 may be a server that provides a motion training guide service or may have a form of an application which can be executed on a predetermined apparatus. The server may provide the motion training guide service to an authenticated user through membership or personal information input.

The application may be installed in the user terminal 200 to be executed. The user terminal 200 may receive a sensing value from the sensor 10 in a state where the application is executed and provide the motion training guide service. As such, the motion training guide system 100 may be the server itself for a motion training guide, or may be an application that is realized in software on a device such as the user terminal 200.

The motion training guide system 100 can output various types of information through own output means (a display, a speaker, and the like) to provide the information to an administrator or a user, and may output the corresponding information to the user terminal 200 which is connected.

The user terminal 200 may refer to a device which can be connected to a network to exchange information, such as a PC, a tablet, a notebook, a pad, a smart phone, or the like. Here, in a case of a device (smartphone, notebook, pad, or the like) having a wireless function, a function of the system 100 may be provided on the device in a form of a mobile application.

The user terminal 200 may receive a sensing value from the sensor 10, provide the sensing value to the motion training guide system 100, and output analysis results of the system 100 on the screen.

The user terminal 200 refers to a user terminal that can be connected to the motion training guide system 100. Of course, a user may include a concept of a ‘learner’

In the following embodiments of the present disclosure, the term “motion” may have meaning including a motion, a motion pattern, and the like for fitness, health, yoga, sports, rehabilitation, and other performances. As a simple example, motion such as “push-up”, “forearm plank”, and “squat” may be included in the motion.

Hereinafter, configuration elements of the system 100 according to the embodiment of the present disclosure will be described in detail.

First, the data collection unit 110 collects motion data obtained at the time of an setting motion (for example, a push-up motion) of a user by using N sensors 10 individually attached to N regions of the user, for a plurality of users.

At this time, a plurality of users may be a trainer, a lecturer, and the like, or may include a skilled user, a general user, and the like. In addition, the setting motion may correspond to the various exercise motions described above.

The motion data may include at least one of a movement angle, a moving distance, a moving speed, a posture holding time, and a motion repetition period of a region where the sensor is attached, as data processed from the sensing value of the sensor 10.

The collected data is used for data learning. The embodiment of the present disclosure can acquire a correct motion data range (reference motion range) corresponding to the setting motion through a deep learning of data measured from a plurality of users. At this time, since the sensors 10 are attached to each of a plurality of regions of the user, the reference motion range can be acquired for each region where the sensors 10 are attached.

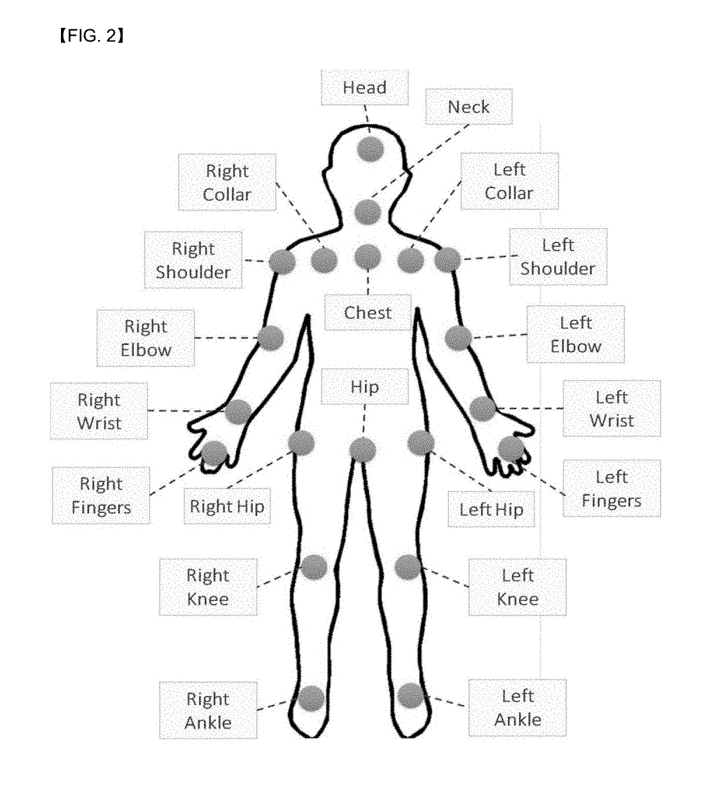

FIG. 2 is a view illustrating a sensor attachment position for data learning in the embodiment of the present disclosure.

FIG. 2 illustrates a state where the sensors 10 are respectively attached to 20 different regions including a head, torso, two arms, two legs, two hands, two feet, and the like of a user (N=20). Of course, the number of sensors used for data learning can be varied from 17 to 20, and it is desirable to use at least 15 sensors or more such that the sensors can be applied to various motions or exercise postures.

The storage unit 120 does deep learning of the motion data collected for a plurality of users to acquire a reference motion range of each region corresponding to the setting motion, and stores the reference motion range. it is possible to distinguish between a normal motion range and an abnormal motion range or a motion range corresponding to noise.

At this time, the storage unit 120 may do deep-learning of the motion data according to a plurality of types of body conditions classified from the plurality of users, and may acquire, classify, and store the reference motion range of each of N kinds of regions by body condition.

Here, the body conditions may include at least one of sex, an age, a weight, and a height. According to this, a plurality of body types may be classified depending on one or a combination of the sex, the height, the age, and the weight.

If the deep learning of the motion data is done by each type of body conditions, the reference motion range corresponding to each body type can be obtained. Accordingly, for example, in a case of a learner with ‘height: 160 cm, weight: 50 kg, gender: female’, the reference motion range matching the corresponding body type is extracted from the storage unit 120, results obtained by comparing the reference motion range with actual motion data of the learner are provided to the user terminal 200 in real time, and thereby, the learner can be instructed to take a correct motion and posture.

As such, after the reference motion range for each region for the setting motion (for example, push-up motion) is acquired, the minimum number of sensors (M sensors) less than N is attached to an actual learner and the learner is tested. That is, the test is performed in a state where the sensors 10 are attached toly on partial regions among the N regions.

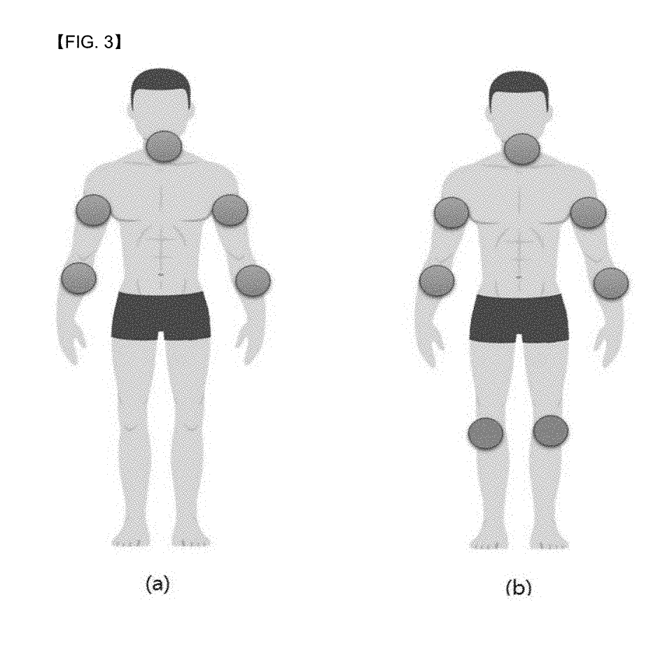

FIGS. 3A and 3B are views illustrating a state where sensors are attached to regions of the body of a learner according to the embodiment of the present disclosure.

In the embodiment of the present disclosure, a case where the minimum number of attached sensors (initial attachment number) is five (M=5) is used as a representative example. However, an M value which is the minimum number of the attached sensors can be selectively used in the range of 4 to 6 (4≤M≤6) so as to satisfy both accuracy of a motion analysis and simplification of the number of attached sensors.

In the following embodiment, a case where the sensors 10 are attached to each of five regions including a neck, right and left elbows, and right and left knees and testing is performed will be described as an example. Of course, the learner may arbitrarily select desired attachment regions and the number of attached sensors.

In addition, the user terminal 200 may receive the attachment positions of the respective sensors 10 from a user and register the attachment positions in a sensor registration unit (not illustrated) included in the system 100. The system 100 includes a matching unit (not illustrated) and matches the x, y, and z coordinate systems of the respective sensors 10 with the positions of regions of the body to which the sensors are actually attached, and thereafter, may also receive data of the respective sensors 10.

When the learner performs a setting motion (for example, push-up motion), the provision unit 130 acquires motion data on the five regions through the five sensors 10 attached to the learner. The provision unit 130 may compare the motion data of each region with the previously obtained reference motion range, and then output the comparison result of each region to the user terminal 200 in real time, thereby, guiding correct motion and posture of the learner therethrough.

Here, of course, the provision unit 130 may extract the reference motion range corresponding to body conditions (height, weight, sex, and the like) of the learner from the storage unit 120 and use the reference motion range as described above.

The provision unit 130 may output the results of comparison of each region and a current state of the learner. For example, reference range information (a movement angle, a moving distance, speed, posture holding time, a motion repetition cycle, and the like) on each region may be compared with the motion data of a current learner and may be provided to the learner.

While the learner compares the own current motion data with the correct motion range (a joint angle, a moving distance, motion holding time, a repetition cycle, and the like) on the corresponding motion with reference to the provided information, the learner may precisely correct postures for each region.

If movements of five regions are all within the reference motion range, it may be determined that the postures are substantially corrected for the corresponding motions. That is, this case indicates that repetition training for a desired motion can be done only by the minimum number (five) of sensors.

Here, if the movement of five regions satisfy all the reference motion ranges and the amount of exercise consumed by the learner until now satisfies the reference amount of exercise for the corresponding motion (push-up motion), it means that the learner performs the corresponding motions in correct postures and correction of postures is completed.

However, even if the movement of five regions satisfy all the reference motion ranges, if the current amount of exercise of the learner is below the reference amount of exercise, it may mean that motion data on regions other than the existing five regions is additionally required or correction of the postures for other regions is additionally required. In this case, the learner may be requested to additionally attach the sensors 10 and to measure the motion again.

For this, the determination unit 140 determines whether or not the motion data on each of the M regions satisfies all the reference motion ranges, and, if the motion data satisfies the reference motion range, the determination unit 140 compares the amount of exercise of the learner calculated based on the motion data with the reference amount of exercise on the setting motion.

For example, the current amount of exercise of the learner is predicted or calculated by using the motion data on the five regions obtained during the push-up motion of the learner, and then the current amount of exercise of the learner is compared with the reference amount of exercise for the push-up motion. At this time, the reference amount of exercise may be applied automatically and variably depending on the actual exercise time of the learner or the number of repetitions.

Here, the amount of exercise may include the amount of consumption or the amount of increase of at least one of body fat, calories, a weight, and muscle mass. In addition, the amount of exercise of the learner may be calculated based on the motion data of the M sensors 10 obtained at the time of a setting motion of the learner, or may be acquired by a direct body composition measuring device such as the Inbody. The embodiment of the present disclosure exemplifies a case of the former.

If the amount of exercise of the learner does not satisfy the reference amount of exercise, the notification unit 150 provides a notification message to induce attachment of an addition sensors 10 to a region other than the five regions to remeasure the motion.

Here, the notification unit 150 may select at least one region to which the sensor 10 is additionally attached based on the type of a setting motion (for example, push-up motion) and the position of the M positions of the body to recommend and provide the selected region to the learner.

For example, the notification unit 150 requests the learner to additionally attach the sensor 10 to one knee or both knees of the learner and to measure again. FIG. 3B illustrates a state of a screen in which it is recommended that the sensors 10 are additionally attached to knees (right knee and left knee). As such, when two sensors are attached to both knees, M=5 is updated to M=7.

Here, the notification unit 150 may preferentially select predetermined regions corresponding to positions that are vertically or horizontally symmetrical with at least one of the M regions so as to perform vertically or horizontally balanced attachment of the sensors to the body, and may recommend and provide the selected regions.

In a case of FIG. 3A, five sensors are attached to positions in balance (symmetry) of left and right, but since there is no sensor under an upper half of the body, both knees (right and left knees) may be recommended, or both hips (right and left hips) may be recommended. As such, a balanced motion may be induced in various regions of the body through the sensors attached in the vertically or horizontally balanced manner.

Particularly, in a case of a push-up motion, a motion performed with bent knees is not a correct posture. As such, if the amount of exercise is remeasured by using sensors added to both knees, the amount of exercise can be increased, and furthermore, the reference amount of exercise can be satisfied.

The embodiment of the present disclosure described above is mainly described by using a push-up motion as an example, but the same effect can be obtained by comparing data obtained by doing learning for other motions in the same manner with exercise data of a learner which becomes an actual training target.

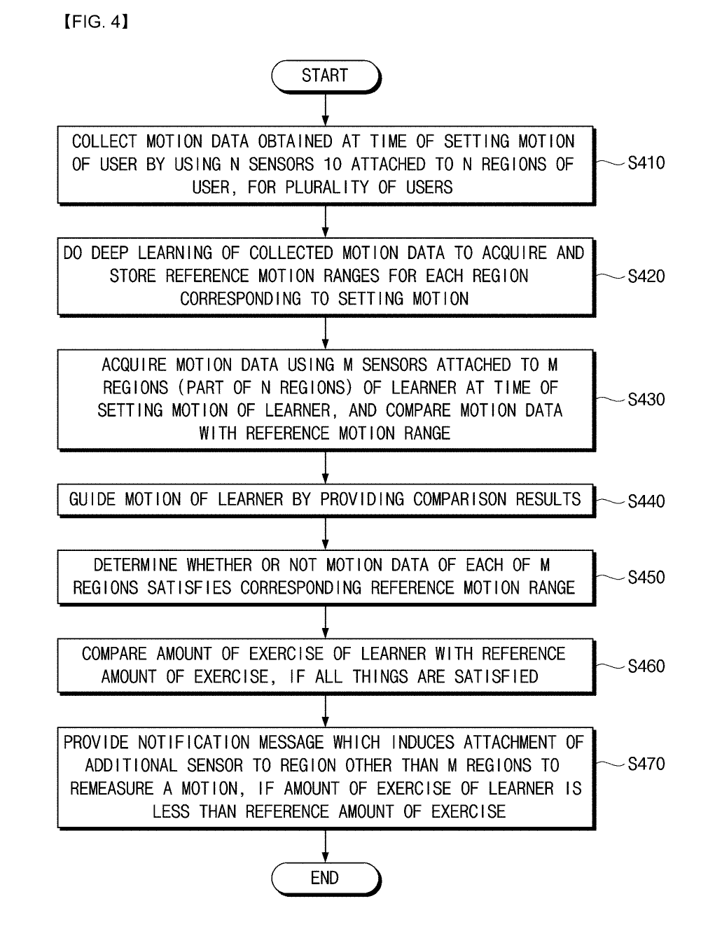

FIG. 4 is a flowchart illustrating a motion training guide method which uses the system of FIG. 1.

First, the data collection unit 110 collects motion data obtained at the time of a setting motion of a user by using the N sensors 10 individually attached to the N regions of the user, for a plurality of users (S410).

The storage unit 120 does the deep learning of the collected motion data to acquire a reference motion ranges for each region corresponding to a setting motion and stores the obtained reference motion range (S420). At this time, body conditions of each user may be classified into various types and the reference motion range may be obtained for each type.

The provision unit 130 acquires motion data using the M sensors 10 attached to the M regions (a part of the N regions) of a learner at the time of the setting motion of the learner, and compares the motion data with a reference motion range (S430), and guides a motion of the learner by providing the comparison results (S440).

Thereafter, the determination unit 140 determines whether or not the motion data of each of the M regions satisfies all the reference motion ranges (S450). If the motion data satisfies all the reference motion ranges, it may be considered that the learner continuously does motion training with correct postures for each of the M regions.

Then, the determination unit 140 compares the amount of exercise of the learner calculated based on the motion data with the reference amount of exercise on the setting motion (S460). At this time, if the amount of exercise of the learner satisfies the reference amount of exercise, the learner may be regarded as fully doing training for corresponding motions by using only the M sensors 10.

However, if the current amount of exercise of the learner does not satisfy the reference amount of exercise even though all the motion data of the M regions satisfy the reference motion ranges, the notification unit 150 provides the learner with a notification message which induces attachment of an additional sensor 10 to a region other than the M regions to remeasure the motion (S470).

At this time, the notification unit 150 may recommend and provide a region of the body requiring attachment of the sensor in consideration of positions of the M sensors 10 currently attached to the learner and motion information (exercise type) of the learner who is in the middle of exercise. At this time, it is recommended that one or two additional sensors are attached.

As such, if the sensor 10 is additionally attached, an M value is updated. That is, if one sensor 10 is attached at the existing M=5, the M value updated to M=6. If the learner to whom a total of six sensors 10 are attached performs step S430 again and the motion is remeasured, additional correction of a posture for a region to which the sensor is additionally attached region may be made.

Of course, if the amount of exercise of the learner does not satisfy the reference amount of exercise even after the additional sensor is attached, a position to which attachment of an additional sensor is required may be further recommended and provided. In this case, the M value is updated again. The above processes may be repeated until the amount of exercise satisfies the reference amount of exercise.

According to the present disclosure described above, there are effects that motion data obtained through sensors attached to each region of a body of a learner when the learner performs a setting motion is compared with a reference motion range previously stored, and thereby, not only correction of postures is induced since the postures for each region corresponding to the setting motion are guided, but also exercise, training, and rehabilitation can be made by attaching only the minimum number of sensors.

In addition, even if the motion data on each region satisfies all the reference motion ranges, if the amount of exercise of the learner is less than the reference amount of exercise, a region to which an additional sensor is attached is recommended and re-measurement for the additional attachment of the sensor is induced, and thereby, accuracy of a posture of the learner for a setting motion can be further increased and the reference amount of exercise can be satisfied.

Furthermore, the present disclosure differently applies reference motion ranges depending on body conditions of a learner so as to support a safe exercise corresponding to the body conditions of the learner, and thereby, injury can be prevented during exercise by preventing a posture from being formed in an excessive size or angle above the body conditions of the learner.

While the present disclosure is described with reference to embodiments illustrated in the drawings, this is simply exemplary, and it will be understood that by the skilled in the art can make various modifications and equivalent embodiments from the embodiments. Accordingly, the true technical scope of the present invention should be determined by the technical idea of the appended claims.

What is claimed is:

1. A motion training guide method based on a wearable sensor comprising:
collecting motion data that is obtained at the time of a setting motion of a user using N sensors which are individually attached to N regions of the user, for a plurality of users;
doing deep learning of the motion data that is collected, and acquiring and storing reference motion ranges of each region corresponding to the setting motion;
acquiring the motion data using M sensors that are attached to M regions (a part of the N regions) of the learner during the setting motion of the learner, comparing the motion data which is obtained with the reference motion ranges, and guiding a motion of the learner by providing comparison results;
comparing the amount of exercise of the learner that is calculated based on the motion data with a reference amount of exercise on the setting motion, if the motion data of each of the M regions satisfies all corresponding reference motion ranges; and
providing a notification message which induces attachment of an additional sensor to a region other than the M regions to remeasure a motion, if the amount of exercise of the learner does not satisfy the reference amount of exercise.

2. The motion training guide method according to claim 1, wherein the amount of exercise includes the amount of consumption or the amount of increase of at least one of body fat, calories, a weight, and muscle mass.

3. The motion training guide method according to claim 1,
wherein the deep learning includes doing deep learning of the motion data on each of a plurality of types of body conditions that are classified from a plurality of users, and acquiring, classifying, and storing the reference motion ranges of each of the regions for each of the body conditions, and
wherein the providing of the comparison results includes extracting the reference motion ranges corresponding to the body conditions of the learner and comparing the motion data that is acquired at the time of the setting motion of the learner with the reference motion range that is extracted.

4. The motion training guide method according to claim 3, wherein the body conditions include at least one of sex, an age, a weight, and a height.

5. The motion training guide method according to claim 1, wherein the providing of the notification message includes selecting at least one region to which additional sensor is attached based on the setting motion and positions of the M regions of the body, and recommending and providing the selected region to the learner.

6. The motion training guide method according to claim 5, wherein the providing of the notification message includes preferentially selecting, recommending, and providing predetermined regions corresponding to positions which are vertically or horizontally symmetrical with at least one of the M regions so as to induce vertically or horizontally balanced attachment of the sensors to the body.

7. The motion training guide method according to claim 1,
wherein M is initially selected in a range of 4≤M≤6, and
wherein the motion data is processed from a sensing value of the sensor and includes at least one of a movement angle, a moving distance, a moving speed, a posture holding time, and a motion repetition period, on the region.

8. A motion training guide system based on a wearable sensor comprising:
a data collection unit configured to collect motion data that is obtained at the time of a setting motion of a user using N sensors which are individually attached to N regions of the user, for a plurality of users;
a storage unit configured to do deep learning of the motion data that is collected and configured to acquire and store reference motion ranges of each region corresponding to the setting motion;
a provision unit configured to acquire the motion data using M sensors that are attached to M regions (a part of the N regions) of the learner during the setting motion of the learner, configured to compare the motion data which is obtained with the reference motion ranges, and configured to guide a motion of the learner by providing comparison results;
a determination unit configured to compare the amount of exercise of the learner that is calculated based on the motion data with a reference amount of exercise on the setting motion, if the motion data of each of the M regions satisfies all corresponding reference motion ranges; and
a notification unit configured to provide a notification message which induces attachment of an additional sensor to a region other than the M regions to remeasure a motion, if the amount of exercise of the learner does not satisfy the reference amount of exercise.

9. The motion training guide system according to claim 8, wherein the amount of exercise includes the amount of consumption or the amount of increase of at least one of body fat, calories, a weight, and muscle mass.

10. The motion training guide system according to claim 8,
wherein, the storage unit does deep learning of the motion data on each of a plurality of types of body conditions that are classified from a plurality of users, and acquires, classifies, and stores the reference motion ranges of each of the regions for each of the body conditions, and
wherein, the provision unit extracts the reference motion ranges corresponding to the body conditions of the learner and compares the motion data that is acquired at the time of the setting motion of the learner with the reference motion range that is extracted.

11. The motion training guide system according to claim 10, wherein the body conditions include at least one of sex, an age, a weight, and a height.

12. The motion training guide system according to claim 8, wherein the notification unit selects at least one region to which additional sensor is attached based on the setting motion and positions of the M regions of the body, and recommends and provides the selected region to the learner.

13. The motion training guide system according to claim 12, wherein the notification unit preferentially selects, recommends, and provides predetermined regions corresponding to positions which are vertically or horizontally symmetrical with at least one of the M regions so as to induce vertically or horizontally balanced attachment of the sensors to the body.

14. The motion training guide system according to claim 8,
wherein M is initially selected in a range of 4≤M≤6, and
wherein the motion data is processed from a sensing value of the sensor and includes at least one of a movement angle, a moving distance, a moving speed, a posture holding time, and a motion repetition period, on the region.
